(19) United States
(12) Patent Application Publication
(10) Pub. No.: US 2004/0163370 A1
(43) Pub. Date: Aug. 26, 2004

(54) Removably mounted filter media kit and method of mounting the same

(76) Inventors: Michael K. Haufe, Upper Arlington, OH (US); Thomas W. Vickers, Circleville, OH (US)

Correspondence Address: KREMBLAS, FOSTER, PHILLIPS & POLLICK, 7632 SLATE RIDGE BOULEVARD, REYNOLDSBURG, OH, 43068, US

(21) Appl. No.: 10/769,836

(22) Filed: Feb. 2, 2004

Related U.S. Application Data
(60) Provisional application No. 60/450,418, filed on Feb. 26, 2003.

(51) Int. Cl. B01D 46/00

(52) U.S. Cl. 55/483

(57) ABSTRACT

A filter media kit assembly and method of mounting and replacing the spent filter media wherein a filter media component and independent retaining and supporting members are used cooperatively to removably mount the filter media within a respective one of a plurality of rigid frames comprising a multiple array of filters forming a grid arrangement. A bag-type filter, having a common central opening and at least two pocket-like areas, is removably mounted within the opening of each frame by entrapping an outer edge portion of the filter media in a press-fit relationship against the inner edges of the sides of the rigid frame forming a central opening. A support rod is provided for insertion across the opening of the frame prior to mounting of the multiple pocket bag filter in the frame and to facilitate and supplement supporting the bag filter in the frame against the air flow applied to the filter grid array during normal operation.

### CROSS-REFERENCES TO RELATED APPLICATIONS

This application claims the benefit of U.S. Provisional Application No. 60/450,418 filed Feb. 26, 2003.

### STATEMENT REGARDING FEDERALLY-SPONSORED RESEARCH AND DEVELOPMENT

(Not Applicable)

### REFERENCE TO AN APPENDIX

(Not Applicable)

### BACKGROUND OF THE INVENTION

1. Field of the Invention

This invention relates generally to particulate air filters and particularly to a more efficiently constructed filter assembly and method using the same wherein each filter is mounted adjacent one another in a grid formed of a plurality of rigid frame.

2. Description of the Related Art

The present invention is directed to air filters for multiple filter grid applications wherein particulates are filtered from an intake or an exhaust air flow.

Past and present practice in the art has included the use of a grid-like structure comprising a plurality of rigid open frames having a filter media component removably mounted in each frame to form a filter bank. Intake or exhaust air is drawn through the filter bank to remove particulate material carried in the air stream.

One typical use of such an arrangement is in paint spray booth applications wherein fine droplets of paint are generated which are considered noxious and must be contained to prevent release into the surrounding environment.

One form of replaceable filter media used in paint spray booths and in some heating, ventilation and air conditioning applications are those in the form of a pocket or multiple pockets of a given depth with the frontal opening to the pocket or pockets conformed to fit within the opening of each rigid frame. This form of filter provides increased surface area to collect the particulate matter, hence increasing the useful life of the filter media unit.

Currently, this form of filter media is supported by a metal ring sewn or otherwise fixed in surrounding relationship to the outside diameter of the opening of the a single or multiple pocket-shaped filter media. One or more metal rods are sewn into the media to separate one media pocket from one another. These metal or other rigid components are sized to be releasably fit in a sealed relationship within the opening of one of the rigid frames in a manner mounting each filter media component in an operable disposition within each frame of the grid.

This construction works very satisfactorily for mounting and dismounting the replaceable filters into the rigid filter frames, however, it represents a significant manufacturing and raw material expense. Further, when the filter media becomes loaded to its capacity, each filter media assembly is replaced and requires disposal, including the metal rod and ring structures fixed to the filter media. The metal components represent a problem in the handling and disposal of such used filter units.

Such a construction has been long used in this industry. A more satisfactory and economical construction and method of mounting has evaded those skilled in this art.

### BRIEF SUMMARY OF THE INVENTION

The present invention provides a new and improved assembly kit for multiple filter grid constructions which is particularly well suited to the multiple pocket form of replaceable filter media.

The filter media layer forming a part of the present invention is preferably formed with two or more pockets and does not incorporate any rigid supporting members non-removably attached to the media. An independent metal retaining ring is included in the kit assembly with an outside diameter selected relative to the opening in the front face of the pocketed filter and the opening of a rigid frame in the filter grid array. The media and ring may be removably mounted within a frame of the filter grid with a portion of the filter media entrapped or held in a friction fit, sealed relationship between the retaining and an inner edge of a rigid frame forming a part of the multiple frame grid array.

In a preferred embodiment, an independent elongate rod is provided as part of the assembly which is configured to a length which may be press fit across the opening of the rigid frame prior to insertion of the filter media component. The rod functions to support the filter media when placed in the frame, as well as facilitate mounting the pocketed filter media layer in the correct disposition within the frame such that the retaining ring may be easily mounted in the desired engaging relationship with a portion of the filter media near its outer edge. The rod may be independent of the rigid frame or may be attached thereto in the appropriate position.

When the filter media component has been loaded to its designed capacity with particulate matter, the retaining ring may be removed from the frame to free the filter media component and a replacement filter media component may be remounted in the frame by repeating the mounting steps described.

It is therefore an object of the present invention to provide an improved replaceable filter media kit assembly which includes a less costly replaceable filter media element for use in a bank of rigid filter frames forming a filter grid array.

It is another aspect of the present invention to provide a filter media kit assembly including supporting and retaining elements independent of the filter media, which are reusable and reduce manufacturing and raw material costs to provide an efficient, less expensive product to the end user.

It is a further object of the present invention to provide a paint booth type filter component which not only is less expensive to manufacture, but also reduces disposal costs to the end user compared to prior filter constructions.

### BRIEF DESCRIPTION OF THE SEVERAL VIEWS OF THE DRAWINGS

FIG. 1 is a perspective view of a conventional array of rigid frames for receiving a plurality of filter media components to form a filter grid;

FIG. 2 is a perspective view of a single rigid frame shown apart from the array illustrated in FIG. 1 showing an elongate support rod forming a part of the filter media assembly in a pre-mounted relationship relative to its mounted operable position within the rigid frame;

FIG. 3 is a perspective view similar to the view in FIG. 2 illustrating the elongate support rod in its mounted operable position with the rigid frame;

FIG. 4 is a perspective view similar to FIG. 3 additionally illustrating the filter media component of the filter assembly in a pre-mounted relationship relative to the rigid frame;

FIG. 5 is a view similar to FIG. 4 illustrating the desired positioning of the filter media within the rigid frame;

FIG. 6 is a perspective view similar to FIG. 5 illustrating the retaining ring in a pre-mounted relationship with the filter media component disposed within the rigid frame as seen in FIG. 5; and

FIG. 7 is a perspective view similar to FIG. 6 illustrating the filter assembly fully mounted within the rigid frame with the retaining ring mounted within the frame as the last step in operatively mounting the filter kit assembly within the rigid frame.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in substantially a similar manner to accomplish substantially a similar purpose.

### DETAILED DESCRIPTION OF THE INVENTION

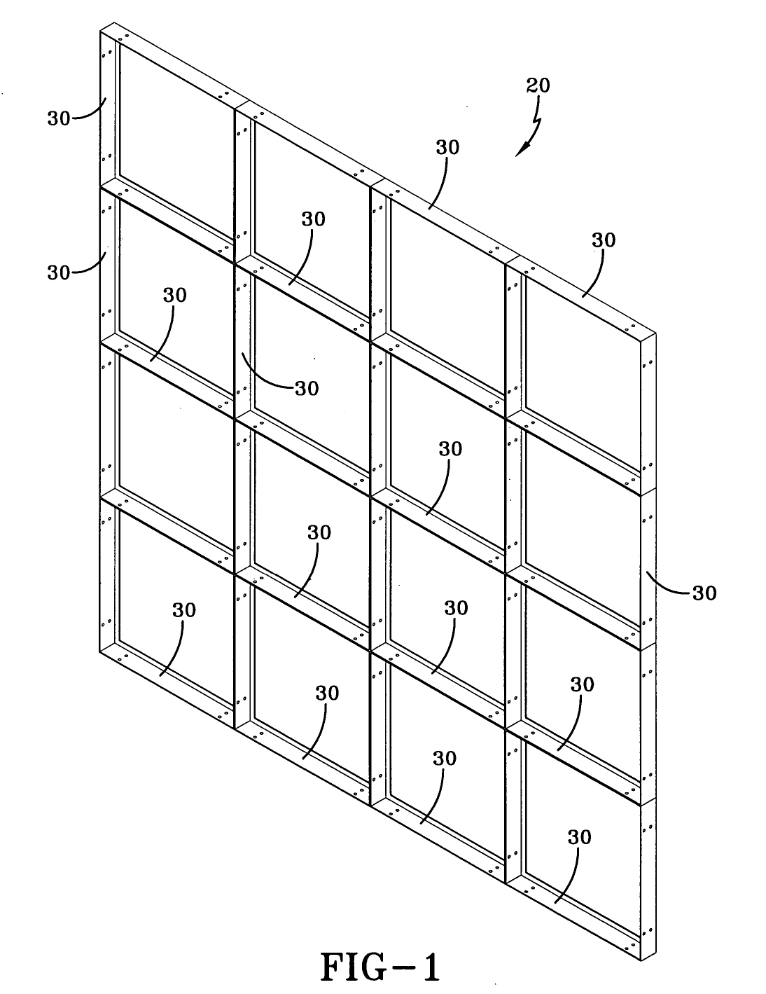

The filter media kit assembly constructed in accordance with the present invention is configured to be removably mounted in a respective one of a plurality of rigid frames, such as 30, which are conventionally connected to one another to form a grid or filter bank in a well-known manner, such as shown in FIG. 1.

A filter media kit assembly constructed in accordance with the present invention includes a filter media layer in the form of a multiple pocket bag 22, a retaining ring 24, and a support rod 26. The retaining ring 24 and support rod 26 are not permanently connected to media layer 22 and may be reused with a similar replacement media layer 22 after the initial layer 22 has reached its designed filter load capacity.

In the preferred embodiment described herein, the bag 22 comprises a layer of non-woven synthetic fibers, however, other suitable filter media material may be employed without departing from the present invention.

Metal retaining ring 24 and support rod 26, being independent of bag 22, are reusable with other similar replaceable bags 22 in a rigid frame 30 of a filter grid array 20. In one preferred example of the present invention, the filter grid 20 typically forms at least one wall, or portion thereof, of a conventional paint spray booth. Air is conventionally drawn through the filter grid array 26 by a fan or suction source, not shown, to create an air stream flow through the grid 20 to carry noxious air borne particulates, primarily paint droplets, to the filter media of the bags 22 mounted therein to prevent release of these particulates into the ambient environment.

The filter bag 2, preferably comprises multiple pockets 23 to increase the surface area exposed to the air flow through the filter grid. In the frequently used two pocket form illustrated in the drawings, each bag 22 includes a frontal opening communicating with the two V-shaped pockets 23. Each pocket 23 includes a pair of opposing side walls 25, and opposing top and bottom walls 27 terminating at a closed trailing end 29 whereby the walls of each pocket taper inwardly toward a respective end 29. The inner side walls 25 of each pocket 23 are joined at a forward edge 31.

The main frontal opening 36 of the bag 22 is configured to generally conform to the shape of central opening 34 in frame 30, which is preferably generally rectangular or square, and is bordered by an outer edge 32 of the filter media material. Outer edge 32 is preferably configured to define an outer circumference of the frontal opening of bag 22 which is approximately equal to or slightly larger than the circumference of the central opening 34 of each rigid frames 30.

Preferably, the outer edge 32 extends no more than one or two inches beyond the central opening 34 when appropriately inserted into the frame 30 to enable bag filter 22 to be easily and properly mounted to frame 30 upon using the retaining ring 24 as described below. As shown in the preferred embodiment, frames 30 of grid array 20 are generally rectangular or square in shape for ease of manufacture and assembly of the filter grid array.

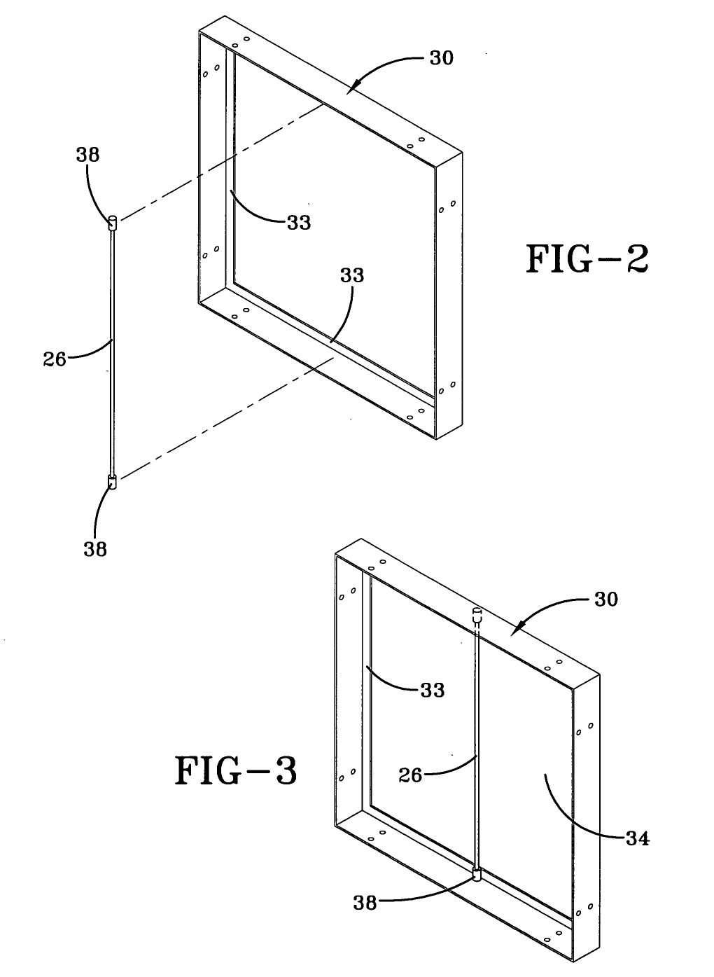

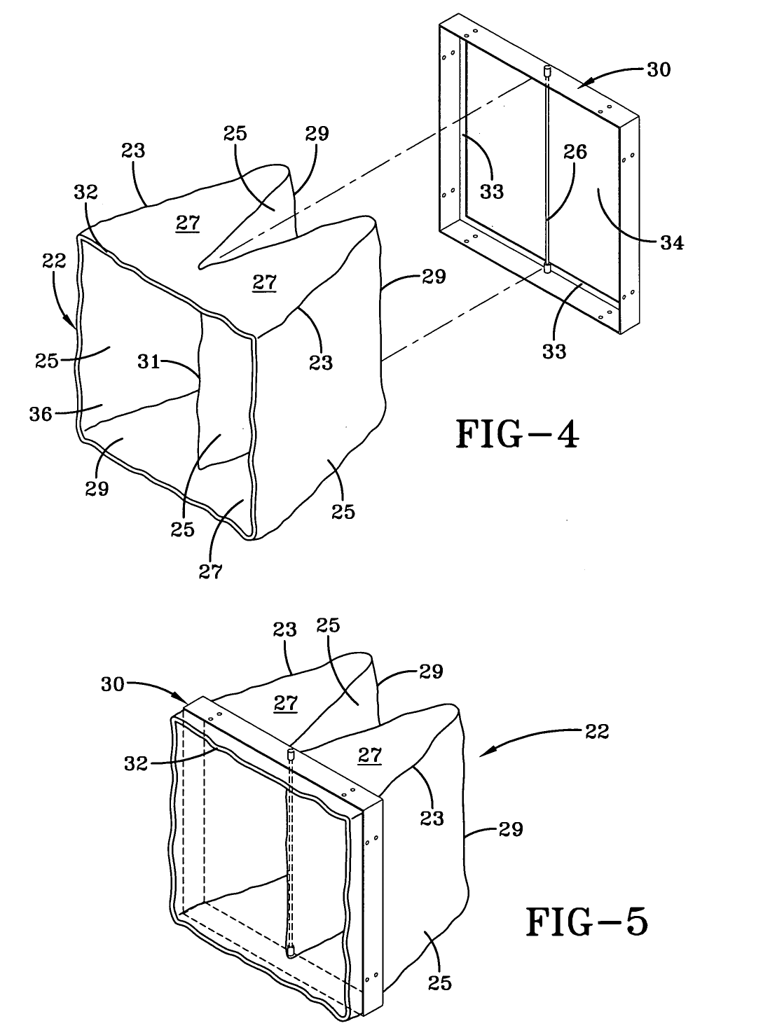

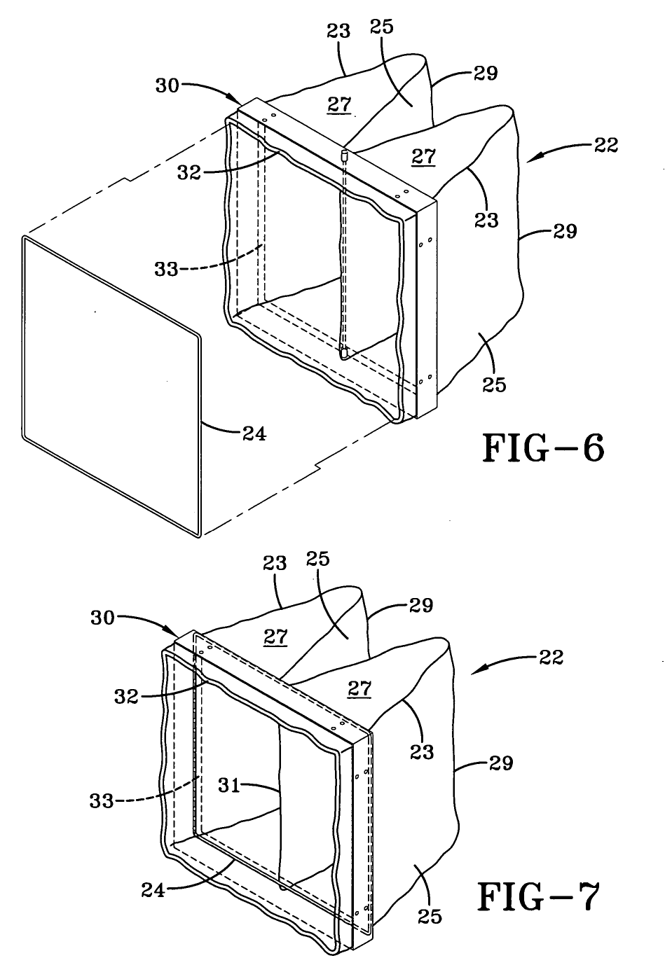

When using a multiple pocket filter bag 22, such as shown, elongate rod 26 is particularly useful for mounting filter bag 22 to a frame 30. Rod 26 preferably is provided with opposing end caps 38 made of resilient material, such as rubber or plastic, which facilitates disposing rod 26 in a press-fit relationship with the inner edges of frame 30 to extend across central opening 34 such as shown in FIGS. 2 and 3. However, other conventional means may be used to removably mount rod 36 within the frame 30.

The user then inserts the rearward ends 29 of pockets 23 into the central opening 34 of frame 30 with the V-shaped space between pockets 23 and leading edge 31 aligned with rod 26. The bag 22 is then inserted into the opening of frame 30 until contact is made with rod 26 which acts as a stop to dispose filter bag 22 at the selected depth within a frame 30. This depth aligns outer edge 32 slightly forward and adjacent to the opposing inner edges 33 defining opening 34 of frame 30. Rod 26 also supplements support of filter bag 22 within frame 30 in conjunction with retaining ring 24 when the bag 22 is subjected to the air flow drawn through the filter bag 22 during normal operation.

As filter bag 22 is inserted into opening 34 of a frame 30, rod 26 will engage the rearward facing joinder 31 of walls 25 of each pocket 23 to prevent further insertion of filter bag 22 into opening 34. As noted earlier, this step also aids alignment of the material of outer edge 32 slightly forward and adjacent to opening 34 in frame 30. The amount of extra material extending forwardly of frame 30 as defined by the distance outer edge 32 extends forwardly of frame opening 34 is not critical. However, it is preferred that it be maintained between no more than about one to two inches so as not to represent waste of the filter material comprising filter bag 22, yet easily provide adequate filter media material to obtain the desired mounted and sealed relationship between the filter material and the inner edge 33 which defines the circumference of frame opening 34.

At this point, retaining ring 24 is aligned with opening 34, inserted within the frontal opening defined by outer edge 32, and then press fit within frame 30 to entrap a portion of filter material inwardly adjacent to outer edge 32 in a sealed relationship against inner edge 33 of frame 30. This releasably fixes the filter kit assembly within a frame 30.

In the normal course of use, filter bags 22 become loaded with particulate matter and require replacement. In accordance with the present invention, retaining ring 24 may be manually freed in a relatively easy manner from its press-fit engagement with frame 30 and the used filter bags 22 may then be removed from the frames 30 for collection and appropriate disposal.

A new filter bag 22 is mounted into each frame 30 as described earlier herein and the retaining ring 24 is reinserted within frame 30 in the same manner as described herein. The elongate rod 26 may be left in its position within opening 34, if desired.

It should be noted that, if other multiple pocket filter bag arrangements are used, additional rods 26 may be used in a similar manner and disposed in a vertical or horizontal position between adjacent pockets of the bag filter to aid in mounting and supporting the bag filter 22 in an operative position in the rigid frame.

While certain preferred embodiments of the present invention have been disclosed in detail, it is to be understood that various modifications may be adopted without departing from the spirit of the invention or scope of the following claims.

1. A filter kit for removable insertion into one of a rigid frames of a filter grid array having a plurality of rigid frames disposed adjacent to one other, each frame having a central opening and arranged in adjacent relationship to one another, said kit comprising in combination;
a) a particulate air filter media component removably mounted in one of said rigid frames, each filter media component provided with multiple, closed end pockets opposing a frontal opening, said frontal opening having an outer edge defining a circumference generally conforming to the circumference of the central opening of a respective one of said rigid frames; and
c) mounting means independent of said filter media bag configured to releasably hold said filter media component within one of said rigid frames, each including a retaining ring member removably mounted in force transmitting engagement to an inner edge of said rigid frame with a portion of said filter media component disposed near said outer edge sealingly entrapped between said retainer ring member and the inner edge of said rigid frame.

2. The filter kit defined in claim 1 further wherein said mounting means includes a rod member removably disposed across said central opening of said frame and in engagement with a rearwardly facing surface of said filter media component located between said pockets and forwardly of said closed ends of said pockets to limit the degree of insertion of said filter media component within said frame in a direction of the intended air flow directed through said filter media component.

3. A method of removably mounting an air filter media component into a rigid frame having four sides and inner edge defining a central opening which forms part of a multiple frame filter grid, comprising the steps of:
a) placing a filter media component across the central opening of the rigid frame with an outer edge portion of said filter media extending forwardly of the inner edge of the central opening of said rigid frame;
b) providing a retaining ring independent of said filter media component and placing said retaining ring in press-fit relationship to the inner edge of the central opening of said frame to engage a portion of said filter media component which is adjacent to said outer edge in force-transmitting relationship between said retaining ring and the inner edges of said frame to releasably secure said filter media component within said frame.

4. A method of mounting and dismounting a replaceable filter media component into a rigid frame forming a portion of a multiple filter grid arrangement, said filter media component having a shape providing a frontal opening communicating with at least two pocket shaped areas extending beyond a downstream side of said frame comprising the steps of:
a) placing a support rod across a central opening of the rigid frame having four sides members defining inner edges surrounding said central opening;
b) inserting the filter media component having at least two pocket shaped areas into said central opening of said frame with the pockets extending through said central opening until a portion of said filter media component between said pockets engages said support rod and aligns an outer edge of said filter media component surrounding said frontal opening forwardly of the inner edges of said rigid frame;
c) placing a retaining ring member into engagement with a portion of said filter media component and in a press-fit relationship with the inner edges of said frame to releasably entrap a portion of said filter media component adjacent to the frontal opening of said filter media component in a sealed relationship between the inner edges of said rigid frame and said retaining ring;
d) upon exhaustion of the useful life of said filter media component, removing said retaining ring member from engagement with said frame and then removing the filter media component from said frame;
e) repeating steps (b) and (c) to place another filter media component in operating relationship within said frame.
